(19) United States
(12) Patent Application Publication
(10) Pub. No.: US 2019/0021384 A1
(43) Pub. Date: Jan. 24, 2019

(54) OLIGOSACCHARIDE COMPOSITION, METHOD, AND USE THEREOF

(71) Applicant: CARGILL INCORPORATED, Wayzata, MN (US)

(72) Inventors: Robert J. BROWER, III, Clayton, OH (US); Ting Liu CARLSON, Marietta, SC (US); Jens EKLÖF, Bagsvaerd (DK); Teresa PAESCHKE, Minneapolis, MN (US); Jappe Wegener TAMS, Bagsvaerd (DK)

(73) Assignee: CARGILL INCORPORATED, Wayzata, MN (US)

(21) Appl. No.: 16/070,353

(22) PCT Filed: Jan. 16, 2017
(86) PCT No.: PCT/US17/13666

§ 371 Date: Jul. 16, 2018

Related U.S. Application Data
(60) Provisional application No. 62/278,749, filed on Jan. 14, 2016.

(51) Int. Cl. A23L 29/262; A23L 33/105; C08B 37/14; A23C 9/13; A23C 9/137; A23L 27/60; A23L 7/126; C08B 37/00; C08L 5/14

(52) U.S. Cl. CPC A23L 29/262; A23L 33/105; C08B 37/14; A23C 9/1307; A23C 9/137; A23L 27/60; A23V 2250/28; C08B 37/0057; C08L 5/14; A23V 2002/00; A23V 2200/14; A23V 2200/242; A23L 7/126

(57) ABSTRACT

The invention provides oligosaccharide compositions, wherein arabinoxylan is present in said composition in amounts of 40-70% (w/w) of dry solid con-tent (DS) and the oligosaccharides have a dispersity (D) of 10-17. The oligosaccharide compositions are useful as bulking agents and for increasing the mouthfeel of a food product.

### CROSS-REFERENCE TO RELATED APPLICATIONS

This application claims the benefit of U.S. Provisional Application Ser. No. 62/278,749, filed Jan. 14, 2016, entitled “Oligosaccharide Composition, Method, and Use Thereof”, which application is incorporated herein by reference in its entirety.

### FIELD

The present invention relates to oligosaccharide compositions suitable for use as bulking agent, emulsifiers and as non-caloric additive in food or feed.

### BACKGROUND

Oligosaccharide compositions, useful in food products, e.g. as a bulking agent, preferably have low viscosity and emulsifying properties, and the ability to positively affect the mouthfeel of the products to which they are added. It is an object of the present invention to provide such compositions and processes from a single step hydrolysis of a highly branched xylan substrate.

Xylans are hemicelluloses found in all land plants (Popper and Tuohy, Plant Physiology, 2010, 153:373-383). They are especially abundant in secondary cell walls and xylem cells. In grasses, with type II cell walls, glucuronoarabinoxylans are the main hemicellulose and are present as a soluble or insoluble dietary fibre in many grass-derived food- and feed products.

Plant xylans have a β-1,4-linked xylopyranose backbone that can be substituted at the O2 or O3 position with arabinose, glucuronic acid and acetic acid in a species and tissue specific manner. The starch-rich seeds of the Panicoideae subfamily of grasses with economically important species, such as corn and sorghum, have special types of highly substituted xylans in their cell walls. Compared to wheat flour that has above 60% of the xylosyl units in the arabinoxylan backbone unsubstituted, the corresponding percentage of unsubstituted backbone xylosyls in corn kernel xylan is 20-30% and 35-40% in sorghum (Huismann et al. Carbohydrate Polymers, 2000, 42:269-279). Furthermore, in corn and sorghum the xylan side chains can be longer than the single substitutions of arabinose or glucuronic acid common in other xylans. Added side chain complexity is given by the presence of L- and D-galactose and xylose. About every tenth arabinose in corn kernel xylans is also esterified with a ferulic acid and about every fourth xylose carries an acetylation (Agger et al. J. Agric. Food Chem, 2010, 58:6141-6148). All these factors combined make the highly substituted xylans in corn and sorghum resistant to degradation by traditional xylanases.

### SUMMARY

It has surprisingly been found that composition which is obtainable by hydrolyzing a highly branched xylan substrate, such as the pericarp portion of corn has unique properties when used as bulking agent.

The invention therefore provides in a first aspect an oligosaccharide composition comprising oligosaccharides, wherein
i) arabinoxylan is present in said composition in amounts of 40-70% (w/w) of dry solid content (DS); and
ii) the oligosaccharides have a dispersity index ( [symbol] ) of 10-17, calculated using the equation [symbol] M=Mw/Mn, where Mw is the weight-average molar mass and Mn is the number-average molar mass.

In a second aspect, the present invention provides use of an oligosaccharide composition as a bulking agent, emulsifier and/or non-caloric additive in food or feed.

In a third aspect, the present invention relates to use of the oligosaccharide composition to enhance or improve the mouthfeel of a food or feed product.

In a fourth aspect, the present invention relates to a method for producing a low-calorie or calorie-reduced food or feed, comprising adding an effective amount of the oligosaccharide composition to food or feed ingredients to produce said food or feed.

In a fifth aspect, the invention pertains to a method for increasing the mouthfeel of a food or feed, comprising adding an effective amount of the composition to food or feed ingredients to produce said food or feed.

In a sixth aspect, the invention provides a food or feed comprising the composition.

In a seventh aspect, the invention provides a method for manufacturing the oligosaccharide composition.

### BRIEF DESCRIPTION OF THE DRAWINGS

FIG. 1 is a graph of an example of a NBA syrup showing shear thinning behavior.

FIG. 2 is a graph of a tribometer measurement of a NBA syrup compared to a 43/43 DE corn syrup.

### DEFINITIONS

Highly branched: “Highly branched” in the context of the present invention means that more than 50% of xylosyl units in the arabinoxylan backbone are substituted, as defined by the ratio of arabinose to xylose of greater than 0.5 in arabinoxylan.

Oligosaccharide composition: The term “oligosaccharide” means oligo- and poly saccharides but does not include mono- and disaccharides (DP1 and DP2). In the context of the present invention, the term “oligosaccharide composition” refers to a composition which comprises oligo- and poly saccharides; it is to be understood that the composition may also comprise certain amounts of mono- and disaccharides.

Xylanase: The term “xylanase” means a 1,4-beta-D-xylan-xylohydrolase (E.C. 3.2.1.8) that catalyzes the endohydrolysis of 1,4-beta-D-xylosidic linkages in xylans. Xylanase activity can be determined with 0.2% AZCL-arabinoxylan as substrate in 0.01% TRITON® X-100 and 200 mM sodium phosphate pH 6 at 37° C. One unit of xylanase activity is defined as 1.0 μmole of azurine produced per minute at 37° C., pH 6 from 0.2% AZCL-arabinoxylan as substrate in 200 mM sodium phosphate pH 6.

Dispersity: “Dispersity” ( [symbol] ) as used herein, is a measure of the distribution of molecular mass in a given polymer sample. Dispersity is calculated using the equation [symbol] M=M_{w}/Mₙ, where M_{w} is the weight-average molar mass and Mₙ is the number-average molar mass

Viscosity: “Viscosity” as used herein refers to the resistance of a fluid to flow. The viscosity of a syrup is typically affected by temperature and dry solids (DS) concentration. Viscosity is expressed in terms of poise (P) or centipoise (cps) at a given temperature and a given % DS

Number average molecular weight: In the present context the term “number average molecular weight” (Mₙ) refers to the total weight of the molecules of interest in a sample, divided by the number of molecules in the sample. The number average molecular weight is calculated as

ΣNᵢMᵢ/ΣNᵢ

where Nᵢ is the number of molecules of weight Mᵢ.

Weight average molecular weight: In the present context the “weight average molecular weight” (M_{w}) is defined as the product of the weight fraction of the molecules of interest in a sample and the weight of each of said molecules. The weight fraction is calculated as

NᵢMᵢ/ΣNᵢMᵢ

where Nᵢ is the number of molecules of weight Mᵢ.

The weight average molecular is calculated as

ΣWᵢMᵢ

where Wᵢ is the weight fraction of molecules of weight Mᵢ.

Shear thinning behavior: In the present context “sheer thinning behavior” refers to behavior of a fluid, which has decreased viscosity when subjected to shear strain; the fluid being a Non-newtonian fluid; i.e., a fluid in which the relation between the shear stress and the shear rate is non-linear.

Boundary regime: In the present context, the term “boundary regime” of a test solution, e.g. an oligosaccharide composition of the invention, refers to a condition in which two surfaces are moving relatively, without being in intimate contact, but being separated by at least one molecular layer of said test solution.

Mixed regime: The term “mixed regime” of a test solution, e.g. an oligosaccharide composition of the invention, refers to a condition in which two surfaces are moving relatively, without being in intimate contact, but being separated an amount of said test solution, wherein parts of said amount of test solution operate hydrodynamically.

Mouthfeel: In the context of the present invention “mouthfeel” refers to the tactile sensation a food gives to the mouth. It is a food product's physical and chemical interactions in the mouth used to describe the overall texture of a food product.

### DETAILED DESCRIPTION

It is an object of the present invention to provide oligosaccharide compositions suitable for use as bulking agents.

In a first aspect, the present invention therefore relates to an oligosaccharide composition, wherein
i) arabinoxylan is present in said composition in amounts of 30-80% (w/w) of dry solid content (DS), such as 40-70% (w/w) of DS; and
ii) the oligosaccharides have a dispersity ( [symbol] ) of 10-20, such as 10-17.

In particular embodiments, the arabinose:xylose ratio in said arabinoxylan may be 0.5 or higher; such as within the range of 0.5-1, within the range of 0.525-1, within the range of 0.55-1, within the range of 0.575-1, within the range of 0.6-1, within the range of 0.7-1, within the range of 0.5-1, within the range of 0.5-0.7, within the range of 0.5-0.675, within the range of 0.5-0.65, within the range of 0.5-0.625, within the range of 0.5-0.6, within the range of 0.525-0.675, within the range of 0.525-0.65, within the range of 0.525-0.625, within the range of 0.55-0.675, within the range of 0.55-0.65, within the range of 0.55-0.625, within the range of 0.575-0.675, within the range of 0.575-0.65, or such as within the range of 0.575-0.625.

In another aspect, the present invention relates to an oligosaccharide composition comprising arabinoxylan having 30-80% (w/w) of dry solid content (DS), such as 40-70% (w/w) of DS, wherein arabinose:xylose ratio in the arabinoxylan is 0.5 or higher.

Preferably, the oligosaccharides in the composition according to the invention have a weight average molecular weight of 10,000-100,000 daltons, such as 10,000-90,000 daltons, 10,000-80,000 daltons, 10,000-70,000 daltons, 10,000-60,000 daltons, 10,000-50,000 daltons or such as 10,000-40,000 daltons.

In preferred embodiments, arabinoxylan is present in said composition in amounts of 40-70% (w/w) of dry solid content (DS); the oligosaccharides have a dispersity index ( [symbol] ) of 10-17, and the oligosaccharides in said composition have a weight average molecular weight of 10,000-50,000 daltons, such as 10,000-40,000 daltons.

In preferred embodiments, arabinoxylan is present in said composition in amounts of 40-70% (w/w) of dry solid content (DS), wherein arabinose:xylose ratio in the arabinoxylan is 0.5 or higher, and the oligosaccharides in said composition have a weight average molecular weight of 10,000-50,000 daltons, such as 10,000-40,000 daltons.

In preferred embodiments, arabinoxylan is present in said composition in amounts of 40-70% (w/w) of dry solid content (DS), wherein arabinose:xylose ratio in the arabinoxylan is 0.5 or higher; the oligosaccharides have a dispersity index ( [symbol] ) of 10-17, and the oligosaccharides in said composition have a weight average molecular weight of 10,000-50,000 daltons, such as 10,000-40,000 daltons.

The amount of monosaccharides may be 10% (w/w) of the amount of dry solids or more, such as within the range of 10-40% (w/w), within the range of 10-35% (w/w), within the range of 15-40% (w/w), or within the range of 15-35% (w/w) of the amount of dry solids. Prefereably, the the amount of oligosaccharides are within the range of 10-40% (w/w) of the amount of dry solids. The oligosaccharide composition according to the invention may in particular be a stable syrup, such as a syrup, which has a dry solid content of 50% (w/w) or more, such as 60% (w/w) or more, or such as 65 (w/w) or more.

At 24° C. and a dry solid (DS) content of 10% the oligosaccharide composition according to the invention may have a viscosity in the range from 2.0-6.0 cps; particularly in the range of 2.5-5.5 cps.

In some embodiments, the invention provides an oligosaccharide composition, wherein the dry solid content (DS) in said composition must be 30% (w/w) or more, such as 35% (w/w) or more or such as 40% (w/w) or more, in order for said composition to display shear thinning behavior. Preferably, display shear thinning behavior is displayed at a dry solid content (DS) of 40% (w/w) or more.

The oligosaccharide composition according to the invention may have a tribological profile comprising a Boundary Regime at a sliding speed of less than 5 mm/s; e.g. less than 4 mm/s, less than 3 mm/s, less than 2 mm/s, less than 1 mm/s or less than 0.5 mm/s and a Mixed Regime at a sliding speed from 0.5-200 mm/s, such as from 1-200 mm/s, from 2-200 mm/s, from 3-200 mm/s, from 4-200 mm/s or from 5-200 mm/s, when the friction factor (coefficient of friction) for the oligosaccharide composition is determined in a tribometer as a function of sliding speed, using elastomer plate(s) as sliding surface(s).

Preferably, the oligosaccharide composition is characterized by a tribological profile comprising a Boundary Regime at a sliding speed of less than 1 mm/s and a Mixed Regime at a sliding speed from 1-200 mm/s when the friction factor (coefficient of friction) for the oligosaccharide composition is determined in a tribometer as a function of sliding speed, using elastimer plate(s) as sliding surface(s).

The oligosaccharide composition according to the invention may in particular be characterized by a tribological profile wherein the friction factor (coefficient of friction) decreases by 15% or less, such as 10% or less, or such as 8% or less, when the sliding speed increases from 3 mm/s to 50 mm/s, when the friction factor (coefficient of friction) for the oligosaccharide composition is determined in a tribometer as a function of sliding speed, using elastimer plate(s) as sliding surface(s). In particular embodiments, the oligosaccharide composition according to the invention is characterized by a tribological profile wherein the friction factor (coefficient of friction) decreases by 10% or less when the sliding speed increases from 3 mm/s to 50 mm/s.

The present inventors have observed that the oligosaccharide compostions according to the invention provide an improved mouthfeel when added to a food product. As the skilled person will know, particular tribological properties of food ingredients may be associated with increased mouthfeel; see e.g. discussion in U.S. Pat. No. 8,413,481 and U.S. Pat. No. 8,324,032. Hence, without wishing to be bound by theory, the inventors propose that improvement in mouthfeel results at least in part from the unique tribological properties of the oligosaccharide composition as disclosed herein.

The oligosaccharide composition according to the invention may in particular be one which is obtainable by hydrolyzing a highly branched xylan substrate, such as the pericarp portion of corn.

Further, the oligosaccharide composition according to the invention may be obtainable by contacting a highly branched xylan substrate, such as the pericarp portion of corn, with a whole-broth or whole-broth lysate of Humicola insolens.

In particular embodiments the said whole-broth or whole-broth lysate of Humicola insolens may comprise
i) polypeptide(s) having endoglucanase activity in amounts corresponding to 35-50% (w/w) of the total amount of enzyme protein in said whole-broth or whole-broth lysate;
ii) enzyme of glycoside hydrolase family 10 (GH10) in amounts corresponding to 5-8% (w/w) of the total amount of enzyme protein in said whole-broth or whole-broth lysate;
iii) enzyme of glycoside hydrolase family 11 (GH11) in amounts corresponding to 6-12% (w/w) of the total amount of enzyme protein in said whole-broth or whole-broth lysate;
iv) enzyme of glycoside hydrolase family 62 (GH62) in amounts corresponding to 0.5-3% (w/w) of the total amount of enzyme protein in said whole-broth or whole-broth lysate; and
v) enzyme of glycoside hydrolase family 5 (GH5) in amounts corresponding to 0.01-1% (w/w) of the total amount of enzyme protein in said whole-broth or whole-broth lysate.

For the purpose of the present invention, the amounts of polypeptide(s) having endoglucanase activity and the enzymes of the GH10, GH11, GH62, and GH5 families may be determined by a method comprising the steps of:
i) Precipitating a sample of said enzyme composition with Trichloroacetic acid (TCA);
ii) Identifying each polypeptide having endoglucanase activity and each enzyme of the GH10, GH11, GH62 or GH5 family by tandem mass spectrometry (MS/MS) analysis of peptides released by tryptic digestion; and
iii) Quantifying each polypeptide having endoglucanase activity and each enzyme of the GH10, GH11, GH62 or GH5 family based on the mass spectrometry signal response of the three best ionizing peptides to each polypeptide having endoglucanase activity and each enzyme of the GH10, GH11, GH62 or GH5 family, respectively.

In further embodiments of the invention, the composition is obtainable by a process comprising the steps of:
i) separating corn fiber from other constituents of corn kernel by wet milling;
ii) cleaning the corn fiber with water to remove bisulfite, residual starch, protein and organic acids;
iii) dewatering the cleaned corn fiber;
iv) providing a suspension of the corn fiber in alkaline water at 7.5% dry solids at 90-85° C. for 3 hours to solubilize a portion of the fiber, which is hemicellulose;
v) adjusting the pH of said suspension to pH 5-6 and incubating the suspension with a whole-broth lysate of Humicola insolens, such as a whole-broth lysate of Humicola insolens defined in any of claims 10-12, at 50° C. to reduce viscosity and molecular weight of said hemicellulose;
vi) separating said composition into a insoluble portion and an insoluble portion; and
vii) optionally purifying said soluble portion of the composition and/or removing water from said soluble portion to produce a concentrated syrup, such as a syrup with at least 50% dry solids.

A further aspect of the invention pertains to the use of the oligosaccharide composition of the invention as a bulking agent, emulsifier and/or non-caloric additive in food or feed

An even further aspect of the invention pertains to the use of an oligosaccharide composition of the invention to enhance or improve the mouthfeel of a food or feed product.

Another aspect of the invention provides a method for producing a low-calorie or calorie-reduced food or feed, comprising adding an effective amount of the composition as defined above to food or feed ingredients to produce said food or feed.

Still another aspect of the invention provides a method for increasing the mouth-feel of a food or feed, comprising adding an effective amount of the composition defined herein to food or feed ingredients to produce said food or feed.

The invention further provides a food or feed comprising a oligosaccharide composition as defined herein.

In particular, the food or feed may be selected from the group consisting of a cereal product, a dairy product, and an oil emulsion, such as an oil-in-water or water-in-oil emulsion.

The food or feed provided according to the invention may in particular be an acidified milk product or dairy product.

In further embodiments, the food or feed according to the invention is selected from the group consisting of a vinaigrette, a mayonnaise, a granola bar, an ice cream, and a yogurt.

In the aspects and embodiments of the invention, which relate to food or feed products, the oligosaccharide composition may be included in said food or feed products in amounts which are within the range of 0.5-50% by weight of the food or feed product, such as within the range of 0.5-40%, within the range of 0.5-30%, within the range of 1-50%, within the range of 1-40%, within the range of 1-30%, within the range of 3-50%, within the range of 3-40%, within the range of 3-30%, within the range of 5-50%, within the range of 5-40%, or within the range of 5-30% by weight of the food or feed product.

The present invention further provides a method for manufacturing an oligosaccharide composition as defined above, comprising the steps of:
i) providing a suspension of corn fiber and solubilizing a portion of the fiber, which is hemicellulose;
ii) incubating the suspension with a whole-broth or a whole-broth lysate of Humicola insolens, such as a whole-broth or a whole-broth lysate of Humicola insolens defined above, under conditions allowing enzymes in said whole-broth or said whole-broth lysate to reduce viscosity and molecular weight of said hemicellulose;
iii) separating said composition into a soluble portion and an insoluble portion; and
iv) optionally purifying said soluble portion of the composition and/or removing water from said soluble portion to produce a concentrated syrup, such as a syrup with at least 50% (w/w) dry solids, at least 50% (w/w), such as at least 60% (w/w) or more, or such as at least 65 (w/w) dry solids or more.

The present invention is further described by the following examples that should not be construed as limiting the scope of the invention.

### EXAMPLES

### Example 1: Method of Producing Soluble Corn Fiber (“NBA”)

“Xylanase 17” is a whole-broth lysate of Humicola insolens. The amount of main enzyme activities in xylanase 17 was determined by protein identification. The protein identification was performed by tandem mass spectrometry (MS/MS) analysis of peptides released by protease digestion. Samples of the whole-broth lysate of Humicola insolens were first TCA precipitated. The protein pellet was solubilized in a Guanidine-HCL denaturation buffer that was heated with DTT for reduction of disulfide bonds followed by alkylation with Iodoaceamide. The samples were then washed and digested with a specific protease like trypsin on a 10 kDa cut-off filter membrane. Following digestion the generated tryptic peptides were extracted and analyzed on an Orbitrap LTQ Velos Pro mass spectrometer (Thermo Scientific) where peptide masses and peptide fragment masses are measured. For data analysis pre-processing Refiner MS software package (GENEDATA) was used for MS peak detection, extraction and quantification. For protein identification the experimentally obtained masses were compared with the theoretical peptide masses and peptide fragment masses of proteins stored in databases by the mass search program Mascot (Matrix science).

For protein quantification the Hi3 method was used where the MS signal response of the three best ionizing peptides to a protein provide a means to determine the absolute concentration of any well characterized protein present in a sample (Mol Cell Proteomics. 2006 January; 5(1):144-56. Epub 2005 Oct. 11.)

The whole-broth lysate of Humicola insolens was found to contain
Endoglucanase: 35-50% (w/w) of the total amount of enzyme protein;
Glycoside hydrolase family 10 (GH10): 5-8% (w/w) of the total amount of enzyme protein;
Glycoside hydrolase family 11 (GH11): 6-12% (w/w) of the total amount of enzyme protein;
Glycoside hydrolase family 62 (GH62): 0.5-3% (w/w) of the total amount of enzyme protein; and
Glycoside hydrolase family 5 (GH5): 0.01-1% (w/w) of the total amount of enzyme protein.

Soluble corn fiber syrup (“NBA”) was produced from the pericarp portion of corn. Corn fiber was separated from the rest of the corn kernel by a typical corn wet milling process that includes softening the kernel with bisulfite and mechanical separation of fiber from germ and endosperm.

145 kg of wet fiber slurry from a corn wet milling plant (22% dry solid, Hammond, Ind.) was mixed with 1450 kg of 70° C. water to remove bisulfite, residual starch, protein, organic acids, and other impurities. The cleaned fiber was dewatered with a Kason vibrating screen fitted with a 10-mesh screen. Cleaned and dewatered fiber was composed primarily of pericarp including cellulose, hemicellulose, and lignin and contained at least 90% fiber by proximate analysis on a dry weight basis. 51 kg of clean fiber at 30% dry solid was mixed with 153 kg of alkaline water (with 1.5 kg of lime) to make a 7.5% dry solid suspension and heated at 90°-95° C. for 3 hours to solubilize the hemicellulose portion of the fiber. The mixture was cooled to 50° C. and neutralized with 1.5 kg of citric acid to pH=5-6. The mixture was then treated with 0.15-0.3 kg of “xylanase 17” at 50° C. for up to 24 hours to further reduce the viscosity and molecular weight of the hemicellulose. Upon completion, the enzyme was inactivated by heating the mixture to 95° C. for 5 minutes. The soluble portion of the mixture was separated from the insoluble fiber by a solid bowl centrifugation and filtered through a 0.5 to 1 micron CUNO filter by 3M. 164 kg of clarified solution of 7% dry solid was further purified by passing through ion exchange chromatography columns packed with cation exchange and anion exchange resins in series at 50° C. (Dowex Optipore SD2, Dowex88, and Dowex 66). 282 kg of 2% dry solid deionized solution was evaporated under vacuum to make a 8% dry solid solution before mixing with 5.6 kg of activated carbon at 50° C. to remove color and impurities. Carbon fines were removed by passing the solution through a 0.5 micron CUNO filter. The purified solution was evaporated under vacuum to generate 3.7 kg of concentrated syrup at 70% dry solid.

The tribometer used in the examples is from the manufacturer Anton Paar; instrument model (controlled stress rheometer): MCR052 serial number 81271030; measuring system model (measuring probe): BC12.7 serial number 9751; accessory (soft lubrication cell): TU1-T-PTD200/Soft serial number 80263616). The tribometer measures friction with logarithmically increasing sliding speed (0.47 to 470 mm/s) under a fixed load (3 N) at 20° C. to generate a friction profile as a function of sliding speed. Such tribometer is described in U.S. Pat. Nos. 8,342,032 and 8,413,481, which are hereby incorporated by reference.

### Results:

### NBA Syrup Analysis:

Three prototype NBA syrups were produced and their compositions are shown below.

Total dry solid was determined by Mettler Toledo moisture balance. Fat content was determined by hexane extraction. Ash content was determined in an ashing furnace at 525° C. overnight. Protein content was measured by Antek nitrogen analyzer after diluting the syrup 1:10 w/w with water. Viscosity measure was done with a Brookfield Viscometer at 24° C.

Arabinoxylan analysis was done by mixing 5 ml of a NBA syrup at 7% dry solid with 1 ml of concentrated HCl and heated at 98° C. for 90 minutes in sealed glass vial. The sample was filtered and analyzed by HPLC using a BioRad Aminex HPX87H column at 50° C. and a refractive index detector. The sugars were eluted off the column isocratically at 0.6 ml/min of 5 mM sulfuric acid.

The increase in xylose and arabinose concentrations after acid hydrolysis was used to quantify arabinoxylan polymer.

The free sugar content in a NBA was measured with the same method as above, but without acid hydrolysis.

Characteristics of the prototype NBAs are provided in table 1.

TABLE 1

| | DYNBA041014 | DYNBA071414 | DYNBA080514 |
|---|---|---|---|
| % DS | 72.5 | 68.9 | 72.4 |
| Protein (DS) | 0.15% | 0.14% | 0.13% |
| Fat (DS) | | 0.64% | 0.52% |
| Ash (DS) | | 1.00% | 0.36% |
| Sugars (DS) | 34% | 18% | 28% |
| Arabinoxylan | 47% | 66% | 57% |
| (DS) | | | |
| Other | 19% | 14% | 14% |
| carbohydrate | | | |
| polymers | | | |
| Arab- | 0.61 | 0.59 | 0.6 |
| inose:xylose | | | |
| ratio in | | | |
| Arabinoxylan | | | |
| Viscosity | 2.52 | 5.04 | 3.72 |
| (10% DS) | | | |
| Mn | 1117 | 3417 | 1374 |
| Mw | 17523 | 37239 | 14982 |
| Polydispersity | 16 | 11 | 11 |
| index | | | |
| (Mw/Mn) | | | |

The results showed that the prototype NBA syrups are highly branched low molecular weight arabinoxylan products with a ratio of arabinoxe to xylose of greater than 0.5 and a weight average molecular weight of 15,000-40,000 daltons.

The polydispersity of the syrups are 11-16. The broad range of the molecular weight distribution gives the product unique properties and low viscosity. Accordingly, the product may be a syrup, having a dry solid content of 60% (w/w) or more, or 65% (w/w) or more, or 70% (w/w) or more, for example, and stable such that the syrup remains flowable under room temperation conditions (e.g., the syrup does not crystallize).

The viscosity of 10% prototype NBA solution is less than or equal to 5 cps at room temperature.

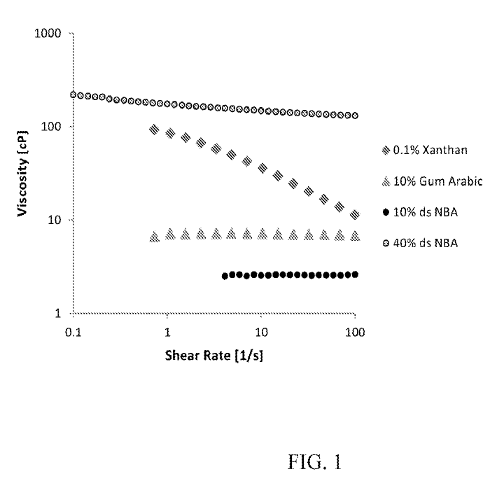

At high prototype NBA concentrations (>40% (w/w) DS), NBA syrup displays weak shear thinning behavior (result from NBA syrup lot #DYNBA041014) (See FIG. 1).

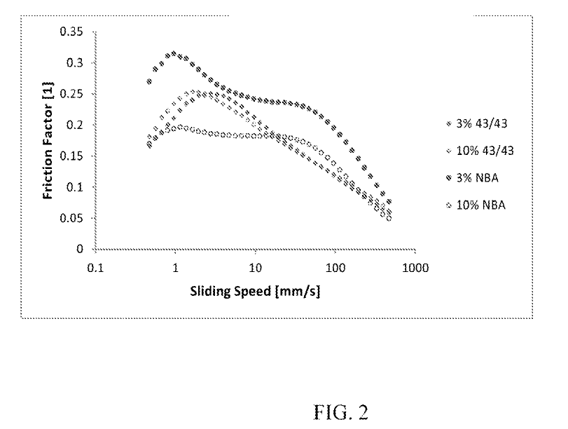

Tribometer measurement of a prototype NBA syrup showed a unique tribological profile compared to a typical 43/43 DE corn syrup (results from syrup lot#DYNBA041014), namely the range of purely boundary friction to purely mixed friction (i.e, boundary regime) is greatly extended over a wider range of sliding speeds than a typical corn syrup (43/43 DE corn syrup) and exhibits a bimodal transition (see FIG. 2).

Boundary regime is defined at around sliding speed of 1 mm/s, Prototype NBA has a maximal friction factor of about 0.325 in a 3% solution, suggesting possible impact on mouthfeel in food applications, similar to those described in liquid foods and fluid food systems (see, Food Measure (2014) 8:142-148; DOI: 10.1007/s11694-014-9174-7; “Normal force-controlled tribological measurement of soft drinks and lubrication additives”).

Mixed regime is in the range of 1-200 sliding speed of mm/s, 3% prototype NBA solution shows a decrease in friction factor of 0.15 over the mixed regime and a friction factor plateau in the region of sliding speed from 3-50 mm/s.

As compared to a typical corn syrup (43/43DE), FIG. 2 shows that prototype NBA solutions behave differently.

### Emulsion Test:

NBA syrup is combined with vegetable oil, citric acid and water with the following formula and mixed at 7500 rpm for 2 minutes. The emulsion is left at room temperature for 24 hours. No oil phase separation was observed after 24 hours for formula containing either NBA syrup or gum arabic. The control solution without any additives showed a clear oil phase after 24 hours of storage.

TABLE 2

| Emulsion | | | | | | |
|---|---|---|---|---|---|---|
| Test | % | g | % | g | % | g |
| Gum arabic | 18.00 | 54.00 | | | | |
| NBA2 | | | 25.39 | 76.16 | | |
| NBA3 | | | | | 24.86 | 74.59 |
| vegetable | 12.00 | 36.00 | 12.00 | 36.00 | 12.00 | 36.00 |
| oil | | | | | | |
| citric acid | 0.30 | 0.90 | 0.30 | 0.90 | 0.30 | 0.90 |
| water | 69.70 | 209.10 | 62.31 | 186.94 | 62.84 | 188.51 |
| | | 300.00 | | 300.00 | | 300.00 |

### Example 2: Food Applications

### A. Italian Vinaigrette

50% reduced fat vinaigrette salad dressing was prepared using the recipe below.

Table 3 shows NBA salad dressing has more emulsifying property than control and showed no separation between oil and water phases. Further, a non-blinded group of five to six tasters participated in taste tests and in roundtable discussions. Sensory evaluations from the tasters showed that the NBA dressing has more flavor as compared to control.

TABLE 3

| Ingredient | Control | NBA |
|---|---|---|
| Oil, soybean, salad or cooking | 54.430 | 27.215 |
| Vinegar, distilled, 200 grain white | 37.710 | 37.710 |
| Garlic, raw | 3.120 | 3.120 |
| Spices, basil, ground | 0.363 | 0.363 |
| Spices, oregano, dried | 0.362 | 0.362 |
| Salt, Kosher, Diamond Crystal-Cargill | 3.810 | 3.810 |
| Spices, pepper, black | 0.205 | 0.205 |
| NBA, LOT DYNBA 080514-Cargill | 0.000 | 27.215 |
| Total | 100.000 | 100.000 |

TABLE 4
Per serving: 2 table-spoons (30 g)

| | Calories | Fat (g) |
|---|---|---|
| Control | 150 | 16 |
| NBA | 80 | 8 |

### B. Chewy Type Granola Bar—25% Reduced Sugar.

25% reduced sugar chewy type granola bars weres made by removing corn syrup and replacing with NBA syrup using the recipe below.

Sensory evaluations from the tasters showed 25% reduced sugar NBA bars having similar textures as full sugar control.

TABLE 5

| | | | batch size (g) | |
|---|---|---|---|---|
| | | | 1500 | |
| | | | Full Sugar | 1500 |
| | | | Control-65 | 25% RS- |
| | | | HMCS | NBA |
| Binder | Supplier | % Solids | % | % |
| Corn Syrup, Satin | Cargill | 81.00% | 20.200 | 3.850 |
| Sweet 65HM | | | | |
| NBA | Cargill | 70.00% | | 16.350 |
| Fructose | Tate & | 99.95% | 1.600 | 1.600 |
| | Lyle | | | |
| Honey | Retail | 82.90% | 8.770 | 8.770 |
| Canola Oil-CV 80 | Cargill | 100.00% | 1.230 | 1.230 |
| Maltodextrin 10DE | Cargill | 94.70% | 0.260 | 0.260 |
| 01909 | | | | |
| Salt-Premier Fine | Cargill | 99.90% | 0.250 | 0.250 |
| Flake | | | | |
| Lecithin-Topcithin SF | Cargill | 99.00% | 0.200 | 0.200 |
| Vanilla Extract | McCor- | 47.42% | 0.200 | 0.200 |
| | mick | | | |
| Baking Soda | Retail | 99.80% | 0.190 | 0.190 |
| Total (Binder) | | | 32.90 | 32.90 |
| | | TSS | | |
| Base | Supplier | Solids | % | % |
| Generic Granola | Cargill | | 35.58 | 35.58 |
| Rice Crisps, Large | Kerry | | 6.12 | 6.12 |
| Almonds, Whole | Retail | | 8.82 | 8.82 |
| Peanuts, dry roasted/no | Retail | | 6.16 | 6.16 |
| salt | | | | |
| Raisins | Retail | | 8.82 | 8.82 |
| Cranberries, sweetened, | Decas | | 1.60 | 1.60 |
| dried | | | | |
| Total Base | | | 67.10 | 67.10 |
| Total (Base + Binder) | | | 100.000 | 100.000 |

### Procedure

1. Combine the base ingredients in a lightly greased mixing bowl.
2. Weigh out corn syrup & honey into saucepan.
3. Weigh remaining dry binder ingredients together in separate container, except sodium bicarbonate.
4. Weigh oil/lecithin/flavor together in separate container.
5. Heat and mix syrup mixture in saucepan to 160° F.
6. Add dry binder ingredients, continue mixing/heating.
7. Heat and mix syrup/water mixture in Vorwerks to 160° F.
8. Add bulking agent at 145° F., increase mixing speed to get into solution.
9. Add dry binder ingredients, continue mixing/heating.
10. Add oil/lecithin/flavor ingredients. Continue mixing and heat to 160° F.
11. Measure the binder over the base and mix well using hands.
12. Measure 1,000 g into bar pan “B”. Press evenly into bar pan using Delrin rolling pin.
13. Cool in refrigerator for 15-20 minutes (until you can pull out of pan without deforming) and cut into bars (3¼″×1¼″).
14. Wrap bars in metallic film.

### C. Plain Yogurt

2.5% NBA syrup dry solid was added to fat free yogurt. From observation, NBA yogurt has more body and thicker texture than fat free control.

TABLE 6

| | Fat | |
|---|---|---|
| Ingredient | Free | NBA |
| Yogurt, plain, whole milk, 8 grams protein per 8 | 0.000 | 0.000 |
| ounce | | |
| Yogurt, plain, skim milk, 13 grams protein per 8 | 100.000 | 96.640 |
| ounce | | |
| NBA, LOT DYNBA 080514-Cargill | 0.000 | 3.360 |
| Total | 100.000 | 100.000 |

### Procedure:

1. Add NBA to Fat Free Yogurt and stir until uniform for a few minutes.
2. Stir skim milk yogurt control for same number of minutes as yogurt containing NBA.

1. An Oligosaccharide composition comprising:
i) 40-70% (w/w) DS arabinoxylan; and
ii) oligosaccharides having a dispersity (Ð) of 10-17.

2. The oligosaccharide composition according to claim 1, wherein the arabinose:xylose ratio in said arabinoxylan is 0.5 or higher.

3. The oligosaccharide composition according to claim 1, wherein said oligosaccharides have a weight average molecular weight of 10,000-100,000 daltons.

4. The oligosaccharide composition according to claim 1, wherein the amount of monosaccharides is 10% (w/w) of the amount of dry solids or more, such as within the range of 10-40% (w/w) of the amount of dry solids.

5. The oligosaccharide composition, according to claim 1, wherein the oligosaccharide composition is a stable syrup having a dry solid content of 60% (w/w) or more.

6. The oligosaccharide composition according to claim 1, wherein the viscosity of said composition at 24° C. and 10% (w/w) DS ranges from 2.0-6.0 cps, preferably 2.5-5.5 cps.

7. The oligosaccharide composition according to claim 1, wherein the composition has shear thinning behavior at 30% (w/w) DS or more, such as 40% (w/w) DS or more.

8. The oligosaccharide composition according to claim 1, wherein said composition is characterized by a tribological profile comprising a Boundary Regime at a sliding speed of less than 1 mm/s and a Mixed Regime at a sliding speed from 1-200 mm/s when the friction factor (coefficient of friction) for the oligosaccharide composition is determined in a tribometer as a function of sliding speed, using elastimer plate(s) as sliding surface(s).

9. The oligosaccharide composition according to claim 1, wherein said composition is characterized by a tribological profile wherein the friction factor (coefficient of friction) decreases by 10% or less when the sliding speed increases from 3 mm/s to 50 mm/s, when the friction factor (coefficient of friction) for the oligosaccharide composition is determined in a tribometer as a function of sliding speed, using elastimer plate(s) as sliding surface(s).

10. The oligosaccharide composition according to claim 1, wherein said composition is obtainable by hydrolyzing a highly branched xylan substrate.

11. The oligosaccharide composition according to claim 1, wherein said composition is obtainable by contacting a highly branched xylan substrate with a whole-broth or whole-broth lysate of Humicola insolens.

12. The oligosaccharide composition according to claim 1, wherein said whole-broth or whole-broth lysate of Humicola insolens comprises:
i) polypeptide(s) having endoglucanase activity in amounts corresponding to 35-50% (w/w) of the total amount of enzyme protein in said whole-broth or whole-broth lysate;
ii) enzyme of glycoside hydrolase family 10 (GH10) in amounts corresponding to 5-8% (w/w) of the total amount of enzyme protein in said whole-broth or whole-broth lysate;
iii) enzyme of glycoside hydrolase family 11 (GH11) in amounts corresponding to 6-12% (w/w) of the total amount of enzyme protein in said whole-broth or whole-broth lysate;
iv) enzyme of glycoside hydrolase family 62 (GH62) in amounts corresponding to 0.5-3% (w/w) of the total amount of enzyme protein in said whole-broth or whole-broth lysate; and
v) enzyme of glycoside hydrolase family 5 (GH5) in amounts corresponding to 0.01-1% (w/w) of the total amount of enzyme protein in said whole-broth or whole-broth lysate.

13. The oligosaccharide composition according to claim 12, wherein the amount of polypeptide(s) having endoglucanase activity and the enzymes of the GH10, GH11, GH62, and GH5 families are determined by a method comprising the steps of:
i) precipitating a sample of said enzyme composition with Trichloroacetic acid (TCA);
ii) identifying each polypeptide having endoglucanase activity and each enzyme of the GH10, GH11, GH62 or GH5 family by tandem mass spectrometry (MS/MS) analysis of peptides released by tryptic digestion; and
iii) quantifying each polypeptide having endoglucanase activity and each enzyme of the GH10, GH11, GH62 or GH5 family based on the mass spectrometry signal response of the three best ionizing peptides to each polypeptide having endoglucanase activity and each enzyme of the GH10, GH11, GH62 or GH5 family, respectively.

14. The oligosaccharide composition according to claim 1, wherein said composition is obtainable by a process comprising the steps of:
i) separating corn fiber from other constituents of corn kernel by wet milling;
ii) cleaning the corn fiber with water to remove bisulfite, residual starch, protein and organic acids;
iii) dewatering the cleaned corn fiber;
iv) providing a suspension of the corn fiber in alkaline water at 7.5% dry solids at 90-85° C. for 3 hours to solubilize a portion of the fiber, which is hemicellulose;
v) adjusting the pH of said suspension to pH 5-6 and incubating the suspension with a whole-broth lysate of Humicola insolens, such as a whole-broth lysate of Humicola insolens defined in any of claims 10-12, at 50° C. to reduce viscosity and molecular weight of said hemicellulose;
vi) separating said composition into a isoluble portion and an insoluble portion; and
vii) optionally purifying said soluble portion of the composition and/or removing water from said soluble portion to produce a concentrated syrup, such as a syrup at at least 50% dry solids.

15. Use of an oligosaccharide composition as defined in claim 1 as a bulking agent, emulsifier, and/or non-caloric additive in food or feed.

16. Use of an oligosaccharide composition as defined in claim 1 to enhance or improve the mouthfeel of a food or feed product.

17. A method for producing a low-calorie or calorie-reduced food or feed, comprising adding an effective amount of a composition as defined in claim 1 to food or feed ingredients to produce said food or feed.

18. A method for increasing the mouth-feel of a food or feed, comprising adding an effective amount of a composition as defined in claim 1 to food or feed ingredients to produce said food or feed.

19. A food or feed comprising a composition as defined in claim 1.

20. The food or feed according to claim 19, selected from the group consisting of a cereal product, a dairy product, and an oil emulsion, such as an oil-in-water or water-in-oil emulsion.

21. The food or feed according to claim 19, which is an acidified milk or dairy product.

22. The food or feed according to claim 20, which is selected from the group consisting of a vinaigrette, a mayonnaise, a granola bar, an ice cream, and a yogurt.

23. A method for manufacturing an oligosaccharide composition as defined in claim 1, comprising the steps of:
i) providing a suspension of corn fiber and solubilizing a portion of the fiber, which is hemicellulose;
ii) incubating the suspension with a whole-broth or a whole-broth lysate of Humicola insolens, such as a whole-broth or a whole-broth lysate of Humicola insolens defined in any of claims 12-13, under conditions allowing enzymes in said whole-broth or whole-broth lysate to reduce viscosity and molecular weight of said hemicellulose;
iii) separating said composition into a soluble portion and an insoluble portion; and
iv) optionally purifying said soluble portion of the composition and/or removing water from said soluble portion to produce a concentrated syrup, such as a syrup at at least 50% dry solids.

24. An oligosaccharide composition comprising 40-70% (w/w) DS arabinoxylan, wherein arabinose:xylose ratio in the arabinoxylan is 0.5 or higher.

25. The oligosaccharide composition of claim 24 further comprising oligosaccharides having a dispersity (Ð) of 10-17.

26. The oligosaccharide composition according to claim 24, wherein said oligosaccharides have a weight average molecular weight of 10,000-100,000 daltons.

27. The oligosaccharide composition according to claim 25, wherein said oligosaccharides have a weight average molecular weight of 10,000-100,000 daltons.
